(19) United States
(12) Patent Application Publication
(10) Pub. No.: US 2004/0178249 A1
(43) Pub. Date: Sep. 16, 2004

(54) Schemes for ultrasonically connecting electrical conductors

(75) Inventor: Kevin Gordon JR., Framingham, MA (US)

Correspondence Address: FOLEY HOAG, LLP, PATENT GROUP, WORLD TRADE CENTER WEST, 155 SEAPORT BLVD, BOSTON, MA, 02110, US

(73) Assignee: Stapla Ultrasonics Corporation, Inc., Wilmington, MA

(21) Appl. No.: 10/389,454

(22) Filed: Mar. 14, 2003

(51) Int. Cl. B23K 1/06

(52) U.S. Cl. 228/110.1; 228/1.1

(57) ABSTRACT

Schemes for ultrasonically connecting electrical conductors are described herein. In one embodiment, a method for ultrasonically connecting electrical conductors can include providing a compaction chamber including a variable cross-section, a bottom bounded by a sonotrode, a first side bounded by a first anvil, a second side bounded by a shaft, and a top bounded by a second anvil disposed on the shaft; disposing the electrical conductors in the compaction chamber opened at the top; displacing the first anvil towards the shaft; displacing the second anvil towards the first anvil; displacing the second anvil towards the sonotrode; and, ultrasonically connecting the electrical conductors.

### BACKGROUND

A variety of schemes for ultrasonically connecting electrical conductors using compaction chambers are currently available. Many of these schemes lack versatility in placing the electrical conductors in the compaction chambers, thereby inhibiting their utility.

### SUMMARY

Schemes for ultrasonically connecting electrical conductors are described herein.

A method for ultrasonically connecting electrical conductors is described herein. In one embodiment, the method can include providing a compaction chamber including a variable cross-section, a bottom bounded by a sonotrode, a first side bounded by a first anvil, a second side bounded by a shaft, and a top bounded by a second anvil disposed on the shaft; disposing the electrical conductors in the compaction chamber opened at the top; displacing the first anvil towards the shaft; displacing the second anvil towards the first anvil; displacing the second anvil towards the sonotrode; and, ultrasonically connecting the electrical conductors.

In one aspect, displacing the first anvil towards the shaft can include displacing the first anvil towards the shaft a distance based on diameters of the electrical conductors.

In one aspect, displacing the first anvil towards the shaft can include displacing the first anvil towards the shaft until the electrical conductors are disposed in a substantially vertical alignment including at least one substantially vertical column of electrical conductors bounded by the first anvil and the shaft.

In one aspect, displacing the second anvil towards the first anvil can include displacing the second anvil towards the first anvil until the second anvil substantially abuts the first anvil.

In one aspect, displacing the second anvil towards the sonotrode can include displacing the second anvil towards the sonotrode a distance based on diameters of the electrical conductors.

In one aspect, displacing the second anvil towards the sonotrode can include displacing the second anvil towards the sonotrode based on a pressure exerted by the second anvil on the electrical conductors.

In one aspect, ultrasonically connecting the electrical conductors can include ultrasonically connecting the electrical conductors disposed in a substantially vertical alignment.

In one embodiment, the method can further include delivering a burst of ultrasonic vibrations to change an alignment of the electrical conductors.

In one embodiment, the method can further include displacing at least one of the first anvil away from the shaft, the second anvil away from the first anvil, and the second anvil away from the sonotrode.

In one embodiment, the method can further include simultaneously displacing the first anvil away from the shaft, the second anvil away from the first anvil, and the second anvil away from the sonotrode.

In one embodiment, the method can further include simultaneously displacing the first anvil away from the shaft and the second anvil towards the first anvil.

In one embodiment, a method for ultrasonically connecting electrical conductors can include providing a sonotrode work surface, a first anvil displaceable in a substantially horizontal direction relative to the sonotrode work surface, and a second anvil displaceable in substantially horizontal and vertical directions relative to the sonotrode work surface; disposing the electrical conductors in a compaction chamber bounded by the sonotrode work surface, the first anvil, and the second anvil; displacing the first anvil towards the second anvil; displacing the second anvil towards the sonotrode work surface; and, ultrasonically connecting the electrical conductors.

In one embodiment, a method for ultrasonically connecting electrical conductors can include disposing the electrical conductors in a compaction chamber bounded by a sonotrode, a first anvil, and a second anvil; displacing the first anvil towards the second anvil until the electrical conductors are disposed in a substantially vertical alignment including at least one substantially vertical column of electrical conductors bounded by the first anvil and the second anvil; displacing the second anvil towards the sonotrode; and, ultrasonically connecting the electrical conductors disposed in the substantially vertical alignment.

A system for ultrasonically connecting electrical conductors is disclosed herein. In one embodiment, the system can include a sonotrode for delivering ultrasonic vibrations on a sonotrode work surface, the sonotrode work surface bounding a bottom of a compaction chamber; a first anvil displaceable in a substantially horizontal direction with respect to the sonotrode work surface, the first anvil bounding a first side of the compaction chamber; a shaft displaceable in a substantially vertical direction with respect to the sonotrode work surface, the shaft bounding a second side of the compaction chamber; a second anvil displaceable in substantially horizontal and substantially vertical directions with respect to the sonotrode work surface, the second anvil disposed on the shaft and bounding a top of the compaction chamber; and, a digital data processing device operatively connected to the first anvil, the second anvil, the shaft, and the sonotrode. The digital data processing device can be capable of displacing the first anvil towards the second anvil after the electrical conductors are disposed in the compaction chamber, displacing the second anvil towards the first anvil, displacing the second anvil and the shaft towards the sonotrode work surface, and activating the sonotrode to ultrasonically connect the electrical conductors.

In one aspect, the digital data processing device can be capable of simultaneously displacing the first anvil away from the shaft, the second anvil away from the first anvil, and the second anvil and the shaft away from the sonotrode after ultrasonic connection of the electrical conductors.

These and other features of the schemes for ultrasonically connecting electrical conductors described herein may be more fully understood by referring to the following detailed description and accompanying drawings. While the drawings illustrate principles of the schemes described herein, they are not drawn to scale, but show only relative dimensions.

### BRIEF DESCRIPTION OF THE DRAWINGS

FIGS. 1A-1G are flow diagrams illustrating an embodiment of a scheme for ultrasonically connecting electrical conductors.

### DETAILED DESCRIPTION

Certain embodiments will now be described to provide an overall understanding of the schemes for ultrasonically connecting electrical conductors described herein. One or more examples of the embodiments are shown in the drawings. Those of ordinary skill in the art will understand that the schemes for ultrasonically connecting electrical conductors described herein can be adapted and modified to provide devices, methods, schemes, and systems for other applications, and that other additions and modifications can be made to the schemes described herein without departing from the scope of the present disclosure. For example, aspects, components, features, and/or modules of the embodiments can be combined, separated, interchanged, and/or rearranged to generate other embodiments. Such modifications and variations are intended to be included within the scope of the present disclosure.

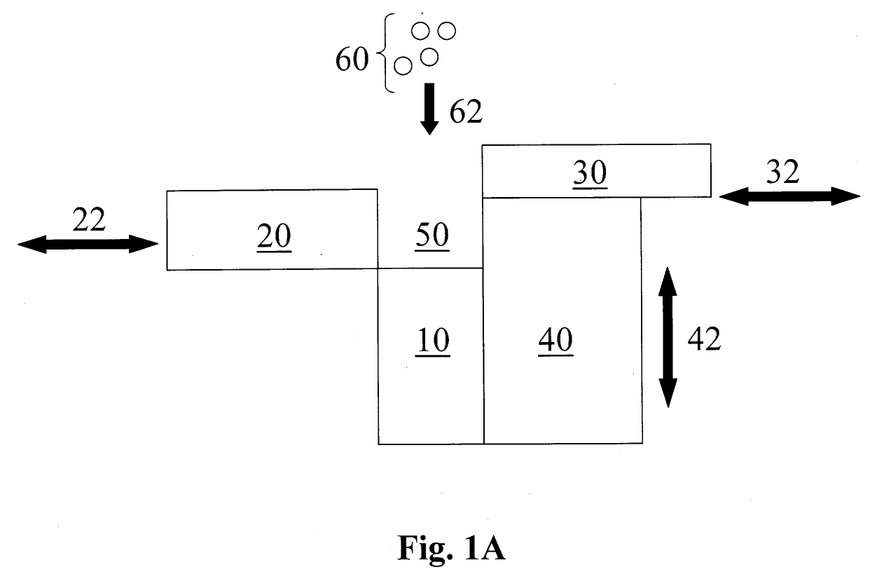

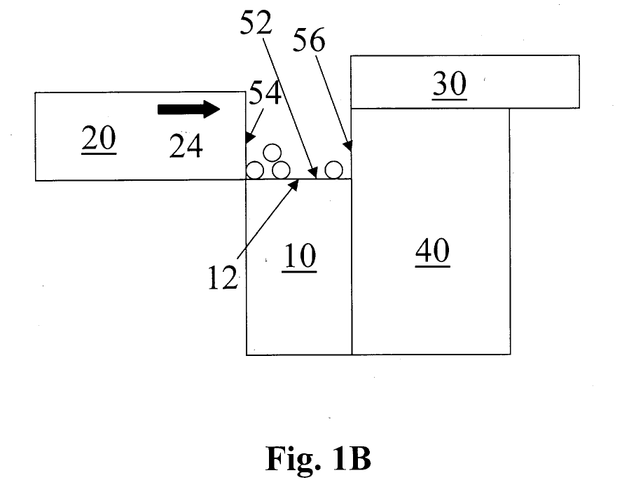

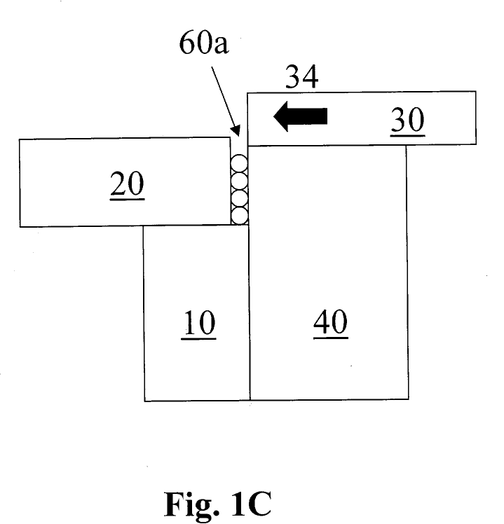

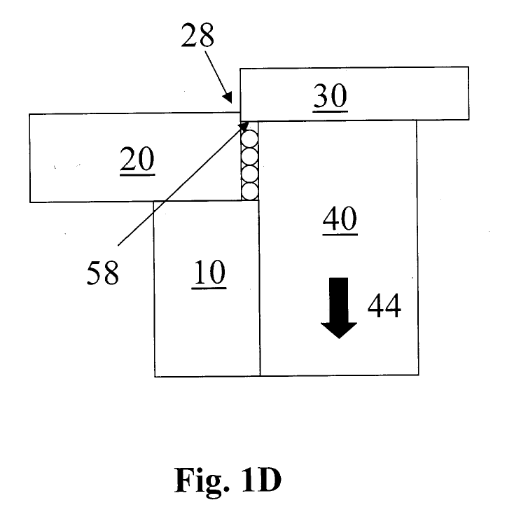

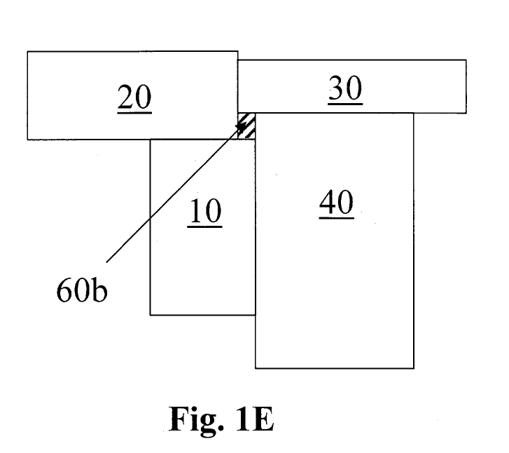

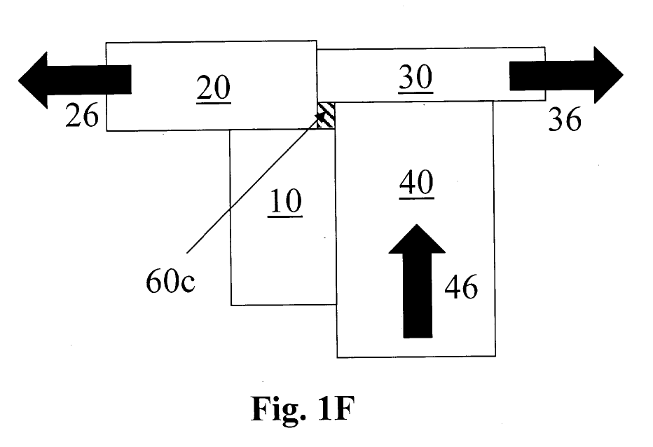

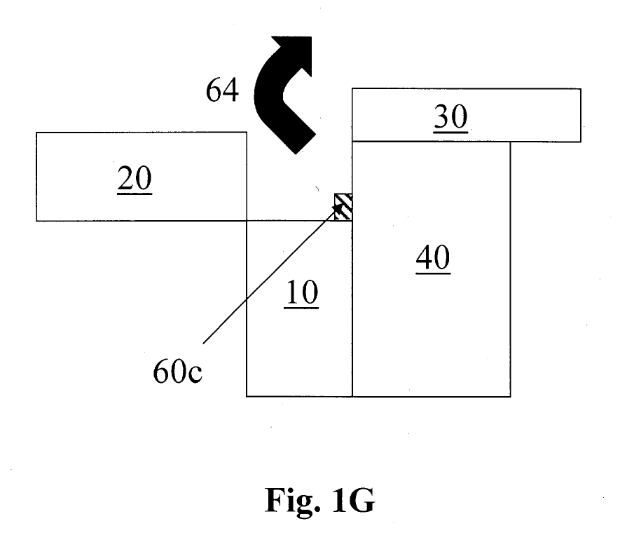

FIGS. 1A-1G show a sonotrode 10 for delivering ultrasonic vibrations on a work surface 12, a first anvil 20, a second anvil 30, a shaft 40 supporting the second anvil 30, a compaction chamber 50, and electrical conductors 60. As will be understood by those of ordinary skill in the art, the sonotrode 10 and the first anvil 20, the sonotrode 10 and the shaft 40, and/or the second anvil 30 and the shaft 40 can be separated by air gaps (not shown) to inhibit direct contact. The electrical conductors 60 can include one or more wires having one or more gauges, constructed from one or more conducting materials, and surrounded by one or more insulating materials. The sonotrode 10, the first anvil 20, the second anvil 30, and the shaft 40 can be similar to devices described in U.S. Pat. Nos. 4,596,352, 4,646,957, 4,869,419, 5,941,443, and 6,079,608, the contents of which patents are expressly incorporated by reference herein.

As shown in FIG. 1A, the first anvil 20 and the second anvil 30 can be displaced in substantially horizontal directions relative to the sonotrode work surface 12, as schematically illustrated by arrows 22, 32, respectively. As also shown in FIG. 1A, the shaft 40 and the second anvil 30 disposed on the shaft 40 can be displaced in a substantially vertical direction relative to the sonotrode work surface 12, as schematically illustrated by arrow 42. The displacement of one or more of the first anvil 20, the second anvil 30, and the shaft 40 can be controlled based on or more schemes familiar to those of ordinary skill in the art. Such schemes can be similar to those described in the U.S. patents previously incorporated by reference herein.

As will be understood by those of ordinary skill in the art, the displacement of one or more of the first anvil 20, the second anvil 30, and the shaft 40 can be controlled by one or more digital data processing devices capable of receiving, processing, and/or transmitting digital data with one or more actuators. The digital data processing devices can include a personal computer, a computer workstation (e.g., Sun, Hewlett-Packard), a laptop computer, a server computer, a mainframe computer, a handheld device (e.g., a personal digital assistant, a Pocket Personal Computer (PC), a cellular telephone, etc.), an information appliance, and/or another type of generic or special-purpose, processor-controlled device capable of receiving, processing, and/or transmitting digital data with the actuators. A processor can refer to the logic circuitry that responds to and processes instructions that drive digital data processing devices and can include, without limitation, a central processing unit, an arithmetic logic unit, an application specific integrated circuit, a task engine, and/or combinations, arrangements, or multiples thereof. A user can interact with a digital data processing device by, for example, viewing a command line, using a graphical and/or other user interface, and entering commands via an input device, such as a mouse, a keyboard, a touch sensitive screen, a track ball, a keypad, etc. The user interface can be generated by a graphics subsystem of a digital data processing device, which renders the interface into an on or off-screen surface (e.g., on a display device and/or in a video memory). The inputs from the user can be received via an input/output subsystem and routed to a processor via an internal bus (e.g., a system bus) for execution under the control of an operating system. The one or more actuators can include electrical actuators (e.g. servo motors), fluid pressure actuators (e.g. fluid pressure pistons and accompanying cylinders), and mechanical actuators (e.g. adjustable screws). As described below, the displacement of one or more of the first anvil 20, the second anvil 30, and the shaft 40 can be controlled based on one or more physical parameters, such as a distance (e.g. a distance between the first anvil 20 and the shaft 40 or a distance between the second anvil 30 and the sonotrode 10) and a pressure (e.g. a pressure exerted by one or more of the first anvil 20 and the second anvil 30 on the electrical conductors 60 disposed in the compaction chamber 50).

As shown in FIGS. 1B and 1D, the compaction chamber 50 can include a bottom 52 bounded by the sonotrode 10, a first side 54 bounded by the first anvil 20, a second side 56 bounded by the shaft 40, and a top 58 bounded by the second anvil 30. As shown in FIGS. 1A-1G, the compaction chamber 50 can include a variable cross-section based on the locations of the first anvil 20, the second anvil 30, and the shaft 40 relative to the sonotrode 10.

As shown in FIG. 1A, the electrical conductors 60 can be disposed in the compaction chamber 50 for ultrasonic connection, as schematically illustrated by arrow 62. In one embodiment, as shown in FIG. 1A, the electrical conductors can be disposed in the compaction chamber 50 opened (i.e. unbounded) at the top 58 and including a maximum cross-section. In such an embodiment, as shown in FIG. 1A, the electrical conductors 60 can be disposed in the compaction chamber 50 in which the first anvil 20, the second anvil 30, and the shaft 40 are disposed at initial or starting locations with respect to the sonotrode 10.

Alternatively, in embodiments, the electrical conductors 60 can be disposed in the compaction chamber 50 in which the first anvil 20, the second anvil 30, and/or the shaft 40 are disposed at locations different than those shown in FIG. 1A. For example, in one embodiment, the electrical conductors can be disposed in the compaction chamber 50 partially closed at the top 58, i.e. partially bounded by the second anvil 30.

As shown in FIG. 1B, in one embodiment, the compaction chamber 50 can be prepared for ultrasonic connection by displacing the first anvil 20 towards the second anvil 30 and the shaft 40, as schematically illustrated by arrow 24. As shown in FIG. 1C, in one embodiment, the first anvil 20 can be displaced towards the second anvil 30 and the shaft 40 until the electrical conductors 60 are disposed in a substantially vertical alignment 60a with respect to each other. As shown in FIG. 1C, in one embodiment, the vertical alignment 60a can include one substantially vertical column of electrical conductors 60 bounded by the first anvil 20 and the second anvil 30 and/or the shaft 40. Alternatively, in embodiments, the vertical alignment 60a can include more than one substantially vertical column of electrical conductors 60. For example, in one embodiment in which the electrical conductors 60 exceed the number of electrical conductors that can be disposed in one vertical column, the vertical alignment 60a can include multiple vertical columns in which adjacent vertical columns are vertically offset with respect to each other, so that electrical conductors in adjacent columns have center points that are vertically displaced with respect to each other. In such a vertical alignment, the electrical conductors 60 can be disposed so that they at least partially overlap adjacent vertical columns. As described below, a vertical alignment, such as the vertical alignment 60a shown in FIG. 1C, can facilitate ultrasonic connection of the electrical conductors 60.

As previously indicated, the displacement of the first anvil 20 can be controlled based on a physical parameter, such as a distance between the first anvil 20 and the second anvil 30 and/or the shaft 40 and a pressure exerted by the first anvil 20 on the electrical conductors 60 disposed in the compaction chamber 50. In one embodiment, the displacement of the first anvil 20 can be controlled based on diameters of the electrical conductors 60. For example, in such an embodiment, the first anvil 20 can be displaced towards the second anvil 30 and/or the shaft 40 a pre-determined distance, i.e. until reaching a pre-determined location with respect to the second anvil 30 and/or the shaft 40. The pre-determined location can be based on a horizontal tool width, i.e. a pre-splice width, for a selected ultrasonic splice. For example, the pre-determined location can be based on a product of the diameters of the electrical conductors 60 and a number of vertical columns selected for the compaction chamber 50. Alternatively, or in combination, in one embodiment, the displacement of the first anvil 20 can be controlled based on a pressure exerted by the first anvil 20 on the electrical conductors 60 disposed in the compaction chamber 50. For example, in such an embodiment, the first anvil 20 can be displaced towards the second anvil 30 and/or the shaft 40 until a pressure sensor disposed near the second side 56 of the compaction chamber 50 measures a pre-determined pressure correlated with a substantially vertical alignment 60a of the electrical conductors 60. In embodiments, the displacement of the first anvil 20 may be controlled by a fluid pressure actuator having a higher operating pressure than a fluid pressure actuator for the second anvil 30.

As shown in FIG. 1C, in one embodiment, the compaction chamber 50 can be further prepared for ultrasonic connection by displacing the second anvil 30 towards the first anvil 20, as schematically indicated by arrow 34. The second anvil 30 can be displaced towards the first anvil 20 after the first anvil 20 comes to rest with respect to the second anvil 30 and the shaft 40. As shown in FIG. 1D, the second anvil 30 can be displaced towards the first anvil 20 until the second anvil 30 substantially abuts (i.e. contacts) the first anvil 20 at an abutment region 28, thus closing the compaction chamber 50. As such, the second anvil 30 can come to rest upon contact with the first anvil 20. As will be understood by those of ordinary skill in the art, the first anvil 20 and the second anvil 30 may be separated by an air gap (not shown) in the abutment region 28 to inhibit direct contact. As previously indicated, the displacement of the second anvil 30 relative to the first anvil 20 can be controlled based on a physical parameter, such as a distance between the second anvil 30 and the first anvil 20.

As shown in FIG. 1D, in one embodiment, the compaction chamber 50 can be further prepared for ultrasonic connection by displacing the second anvil 30 towards the sonotrode 10, as schematically illustrated by arrow 44. The second anvil 30 can be displaced towards the sonotrode 10 after the second anvil 30 comes to rest with respect to the first anvil 20. As will be understood by those of ordinary skill in the art, the displacement of the second anvil 30 towards the sonotrode 10 can be controlled by displacing the shaft 40, which supports the second anvil 30, in a substantially vertical direction with respect to the sonotrode work surface 12.

As previously indicated, the displacement of the second anvil 30 relative to the sonotrode 10 can be controlled based on a physical parameter, such as a distance between the second anvil 30 and the sonotrode 10 and a pressure exerted by the second anvil 30 on the electrical conductors 60 disposed in the compaction chamber 50. In one embodiment, the displacement of the second anvil 30 can be controlled based on diameters of the electrical conductors 60. For example, in such an embodiment, the second anvil 30 can be displaced towards the sonotrode a pre-determined distance, i.e. until reaching a pre-determined location with respect to the sonotrode 10. The pre-determined location can be based on a vertical tool height, i.e. a pre-splice height, for a selected ultrasonic splice. For example, the pre-determined location can be based on a product of the diameters of the electrical conductors 60 and a number of electrical conductors included in a vertical column (e.g. the vertical column of alignment 60a shown in FIG. 1C). Alternatively, or in combination, in one embodiment, the displacement of the second anvil 30 can be controlled based on a pressure exerted by the second anvil 30 on the electrical conductors 60 disposed in the compaction chamber 50. For example, in such an embodiment, the second anvil 30 can be displaced towards the sonotrode 10 until a pressure sensor disposed near the bottom 52 of the compaction chamber 50 measures a pre-determined pressure correlated with a vertical tool height of the substantially vertical alignment 60a. As will be understood by those of ordinary skill in the art, the displacement of the shaft 40 and the second anvil 30 disposed thereon can be based on a variety of factors. For example, in embodiments, the displacement of the shaft 40 and the second anvil 30 can be based on a pre-determined weld time, a pre-determined weld energy, a pre-determined vertical tool height, and/or a pre-determined vertical distance.

As shown in FIG. 1E, in one embodiment, substantially horizontal and/or substantially vertical displacement of the first anvil 20 and the second anvil 30 can generate a compaction chamber 50 having a cross-section adapted for a selected ultrasonic splice. As shown in FIG. 1E, the electrical conductors 60 disposed in the compaction chamber 50 can be compacted to an alignment 60b having a horizontal tool width and a vertical tool height for the selected ultrasonic splice.

As previously indicated, FIGS. 1A-1G are not drawn to scale, but show only relative dimensions. As such, the aspect ratio of the horizontal tool width to the vertical tool height of the ultrasonic splice 60a, 60b, 60c can be different than that shown in FIGS. 1A-1G.

As shown in FIGS. 1E and 1F, the electrical conductors 60 disposed in alignment 60b can be ultrasonically connected to form an ultrasonic splice 60c. The sonotrode 10 can be used to ultrasonically connect the alignment 60b according to schemes familiar to those of ordinary skill in the art. Such schemes can be similar to those described in the U.S. patents previously incorporated by reference herein.

In one embodiment, the sonotrode 10 can deliver a burst of ultrasonic vibrations to change the alignment 60b. For example, the sonotrode 10 can deliver a burst of ultrasonic vibrations to dispose the alignment 60b into a final pre-splicing alignment. In such an embodiment, the burst of ultrasonic vibrations can be used to measure the vertical tool height of the alignment 60b. Provided that the measured vertical tool height corresponds to selected specifications, the sonotrode 10 can be activated to generate splice 60c, as shown in FIG. 1F.

In one embodiment, the electrical conductors 60 can be ultrasonically connected in the substantially vertical alignment 60a shown in FIG. 1C. For example, in one such embodiment, the electrical conductors in alignment 60a can be spliced together. Alternatively, or in combination, the electrical conductors 60 can be connected with electrical conductors disposed in adjacent vertically offset columns. For example, in one such embodiment, one or more electrical conductors disposed in a first column can be connected with one or more electrical conductors disposed in an adjacent vertically offset column.

As shown in FIG. 1F, in one embodiment, the compaction chamber 50 can be opened after splicing the electrical conductors 60 disposed therein by displacing one or more of the first anvil 20, the second anvil 30, and the shaft 40. For example, in one embodiment, the first anvil 20 can be displaced away from the second anvil 30 and the shaft 40, as schematically illustrated by arrow 26; the second anvil 30 can be displaced away from the first anvil 20, as schematically illustrated by arrow 36; and the second anvil 30 can be displaced away from the sonotrode 10, as schematically illustrated by arrow 46. In embodiments, the first anvil 20, the second anvil 30, and the shaft 40 can be simultaneously or sequentially displaced to open the compaction chamber 50.

As will be understood by those of ordinary skill in the art, the splice 60c can become attached to (i.e. can stick to) the corner of the compaction chamber 50 bounded by the second anvil 30 and the shaft 40. In one embodiment, therefore, the first anvil 20 can be displaced away from the second anvil 30 and the shaft 40 and the second anvil 30 can be displaced towards the first anvil 20 to release the splice 60c from the second anvil 30 and/or the shaft 40. The first anvil 20 and the second anvil 30 can be simultaneously displaced. After releasing the splice 60c, the second anvil 30 can be displaced away from the first anvil 20 and away from the sonotrode 10, as previously described.

As shown in FIG. 1G, the first anvil 20, the second anvil 30, and the shaft 40 can be displaced to their initial or starting locations and the splice 60c can be removed from the opened compaction chamber 50, as schematically illustrated by arrow 64. As will be understood by those of ordinary skill in the art, the splice 60c can be removed from the compaction chamber 50 in which the first anvil 20, the second anvil 30, and/or the shaft 40 are disposed at locations different than those shown in FIG. 1G. For example, the splice 60c can be removed from the compaction chamber 50 before the first anvil 20, the second anvil 30, and/or the shaft 40 are displaced to their initial locations. As suggested by FIGS. 1A and 1G, removal of the splice 60c from the compaction chamber 50 can permit another set of electrical conductors 60 to be disposed in the compaction chamber 50 for ultrasonic connection.

While the schemes described herein have been particularly shown and described with reference to certain embodiments, those of ordinary skill in the art will recognize or be able to ascertain many equivalents to the embodiments described herein by using no more than routine experimentation. Such equivalents are intended to be encompassed by the scope of the present disclosure and the appended claims.

For example, in embodiments, the first anvil 20, second anvil 30, and/or the shaft 40 can be displaced according to sequences different than those described herein.

Accordingly, the appended claims are not to be limited to the embodiments described herein, can include practices other than those described, and are to be interpreted as broadly as allowed under prevailing law.

1. A method for ultrasonically connecting electrical conductors, the method including:
providing a compaction chamber including a variable cross-section, a bottom bounded by a sonotrode, a first side bounded by a first anvil, a second side bounded by a shaft, and a top bounded by a second anvil disposed on the shaft,
disposing the electrical conductors in the compaction chamber opened at the top,
displacing the first anvil towards the shaft,
displacing the second anvil towards the first anvil,
displacing the second anvil towards the sonotrode, and
ultrasonically connecting the electrical conductors.

2. The method of claim 1, wherein displacing the first anvil towards the shaft includes:
displacing the first anvil towards the shaft a distance based on diameters of the electrical conductors.

3. The method of claim 1, wherein displacing the first anvil towards the shaft includes:
displacing the first anvil towards the shaft until the electrical conductors are disposed in a substantially vertical alignment including at least one substantially vertical column of electrical conductors bounded by the first anvil and the shaft.

4. The method of claim 1, wherein displacing the second anvil towards the first anvil includes:
displacing the second anvil towards the first anvil until the second anvil substantially abuts the first anvil.

5. The method of claim 1, wherein displacing the second anvil towards the sonotrode includes:
displacing the second anvil towards the sonotrode a distance based on diameters of the electrical conductors.

6. The method of claim 1, wherein displacing the second anvil towards the sonotrode includes:
displacing the second anvil towards the sonotrode based on a pressure exerted by the second anvil on the electrical conductors.

7. The method of claim 1, wherein ultrasonically connecting the electrical conductors includes:
ultrasonically connecting the electrical conductors disposed in a substantially vertical alignment.

8. The method of claim 1, further including:
delivering a burst of ultrasonic vibrations to change an alignment of the electrical conductors.

9. The method of claim 1, further including:
displacing at least one of the first anvil away from the shaft, the second anvil away from the first anvil, and the second anvil away from the sonotrode.

10. The method of claim 1, further including:
simultaneously displacing the first anvil away from the shaft, the second anvil away from the first anvil, and the second anvil away from the sonotrode.

11. The method of claim 1, further including:
simultaneously displacing the first anvil away from the shaft and the second anvil towards the first anvil.

12. A method for ultrasonically connecting electrical conductors, the method including:
providing a sonotrode work surface, a first anvil displaceable in a substantially horizontal direction relative to the sonotrode work surface, and a second anvil displaceable in substantially horizontal and substantially vertical directions relative to the sonotrode work surface,
disposing the electrical conductors in a compaction chamber bounded by the sonotrode work surface, the first anvil, and the second anvil,
displacing the first anvil towards the second anvil,
displacing the second anvil towards the sonotrode work surface, and
ultrasonically connecting the electrical conductors.

13. The method of claim 12, wherein displacing the first anvil towards the second anvil includes:
displacing the first anvil towards the second anvil a distance based on diameters of the electrical conductors.

14. The method of claim 12, wherein displacing the first anvil towards the second anvil includes:
displacing the first anvil towards the second anvil until the electrical conductors are disposed in a substantially vertical alignment including at least one substantially vertical column of electrical conductors bounded by the first anvil and the second anvil.

15. The method of claim 12, wherein displacing the second anvil towards the sonotrode work surface includes:
displacing the second anvil towards the sonotrode work surface based on diameters of the electrical conductors.

16. The method of claim 12, wherein displacing the second anvil towards the sonotrode work surface includes:
displacing the second anvil towards the sonotrode work surface based on a pressure exerted by the second anvil on the electrical conductors.

17. The method of claim 12, wherein ultrasonically connecting the electrical conductors includes:
ultrasonically connecting the electrical conductors disposed in a substantially vertical alignment.

18. A method for ultrasonically connecting electrical conductors, the method including
disposing the electrical conductors in a compaction chamber bounded by a sonotrode, a first anvil, and a second anvil,
displacing the first anvil towards the second anvil until the electrical conductors are disposed in a substantially vertical alignment including at least one substantially vertical column of electrical conductors bounded by the first anvil and the second anvil,
displacing the second anvil towards the sonotrode, and
ultrasonically connecting the electrical conductors disposed in the substantially vertical alignment.

19. The method of claim 18, further including:
displacing at least one of the first anvil away from the second anvil, the second anvil away from the first anvil, and the second anvil away from the sonotrode.

20. The method of claim 19, further including:
simultaneously displacing the first anvil away from the shaft and the second anvil towards the first anvil.

21. A system for ultrasonically connecting electrical conductors, the system including a sonotrode for delivering ultrasonic vibrations on a sonotrode work surface, the sonotrode work surface bounding a bottom of a compaction chamber,
a first anvil displaceable in a substantially horizontal direction with respect to the sonotrode work surface, the first anvil bounding a first side of the compaction chamber,
a shaft displaceable in a substantially vertical direction with respect to the sonotrode work surface, the shaft bounding a second side of the compaction chamber,
a second anvil displaceable in substantially horizontal and substantially vertical directions with respect to the sonotrode work surface, the second anvil disposed on the shaft and bounding a top of the compaction chamber, and
a digital data processing device operatively connected to the first anvil, the second anvil, the shaft, and the sonotrode, the digital data processing device capable of displacing the first anvil towards the second anvil after the electrical conductors are disposed in the compaction chamber, displacing the second anvil towards the first anvil, displacing the second anvil and the shaft towards the sonotrode work surface, and activating the sonotrode to ultrasonically connect the electrical conductors.

22. The system of claim 21, wherein the digital data processing device is capable of simultaneously displacing the first anvil away from the shaft, the second anvil away from the first anvil, and the second anvil and the shaft away from the sonotrode after ultrasonic connection of the electrical conductors.
